(19) United States
(12) Patent Application Publication
(10) Pub. No.: US 2003/0167894 A1
(43) Pub. Date: Sep. 11, 2003

(54) Device for sawing metal with a band saw

(76) Inventor: Patrick Missler, Etiolles (FR)

Correspondence Address: YOUNG & THOMPSON, 745 SOUTH 23RD STREET 2ND FLOOR, ARLINGTON, VA, 22202

(21) Appl. No.: 09/507,046

(22) Filed: Feb. 22, 2000

(30) Foreign Application Priority Data
Feb. 19, 1999 (FR) 99,02059

(51) Int. Cl. B27B 13/00

(52) U.S. Cl. 83/816; 83/591

(57) ABSTRACT

A band saw for sawing metal comprises a movable working assembly (1) comprising a band saw (18) and a drive for the band. The movable working assembly (1) comprises at least two power-driven wheels (16, 17) about which the band saw is trained, located on opposite sides of a passage for the metal to be sawed. This increases the drive surface applied to the band saw (18) while maintaining it under tension.

This application corresponds to French application 99.02059 of Feb. 19, 1999, the disclosure of which is hereby incorporated by reference.

The present invention relates to a device for sawing metals with a band saw, of the type comprising a movable working assembly comprising the band saw and its drive device, as well as means for bringing metal bars below said movable assembly for their

French patent application FR 98.15863 filed Dec. 16, 1998 and not published as of the present filing date, discloses a device for sawing metals with a band saw, of the type comprising a movable working assembly comprising the band saw and its drive device, a means to advance the metal in bar shape below said movable assembly for its sawing, and means for removing what is cut by sawing. This device comprises a rigid frame comprising a base on which is disposed the means to advance the metal bars as well as at least one support for the movable working assembly, so as to support the movable working assembly in front of this base in the direction of advance of the metal and above the means for evacuating what is cut off.

This device is completely satisfactory, is simple and economical to construct, and it sturdy and has excellent productivity.

In this device, as well as in band saws of known type, there is provided a single motor-driven wheel which drives the band by friction above half the periphery of the driven wheel.

To obtain good cutting geometry, the rigidity of the band must be a maximum, which is obtained by placing the band under a tension nearly at the limit of mechanical resistance of the strip constituting the major portion of the band saw.

However, in sawing machines of the known type, the productivity is limited by the tendency for the band saw to slip in contact with the driven wheel when the power of the motor reducer driving the driven wheel is increased. This limitation is particularly to be noted when there is used, instead of a band of high-speed steel, a band with teeth of tungsten carbide. It happens then that, despite the increase or doubling of the drive power for the motorized wheel, the productivity is limited by slipping on the driven wheel, no matter what tension is applied to the band and no matter what the increase of power of the drive motor reducer.

The invention has for its object to overcome these drawbacks, by providing a new device in which the drive surface of the saw band is increased, whilst maintaining it under the required tension almost at the limit of mechanical resistance of the strip of the band saw.

The invention has for its object a device for sawing metals with a band saw of the type comprising: a movable working assembly comprising the band saw and its drive device, as well as means to bring metal bars below said movable assembly for their sawing, characterized in that the movable working assembly comprises at least two driven wheels for the band saw located on opposite sides of the passage for the bars to be sawed, so as to increase the drive surface of the band saw whilst maintaining the latter under tension.

According to other characteristics of the invention:

each motor-driven wheel is driven by means of a hollow shaft reducer,

the two motorized drive wheels are supplied electrically by a frequency converter supply, so as to control the speed of each motor by a common frequency,

each wheel is balanced on two symmetrical bearings, so as to void any transmission of radial force upon their respective drive,

a motor-driven wheel is mounted on the movable assembly with the interposition of an anti-rotation arm provided with a device for measuring the resistive couple, so as to control the speed of descent of the movable working assembly,

the motor-driving means are mounted on opposite sides of the vertical plane passing through the band saw,

a motor-driven wheel is movable with its drive means relative to the structure carrying the movable working assembly in a direction corresponding to the tensioning of the band saw,

each motor-driven wheel comprises an intermediate drive means keyed on an overhanging end of the corresponding wheel shaft,

each intermediate drive means is for example a tubular shaft reducer adapted to be threaded directly on the end of the wheel shaft provided with a key for securing in rotation,

each intermediate drive means comprises an element for securement to an overhanging end of the shaft by means of a demountable means.

The invention will be better understood from the description which follows given by way of non-limiting example, with reference to the accompanying drawings, in which:

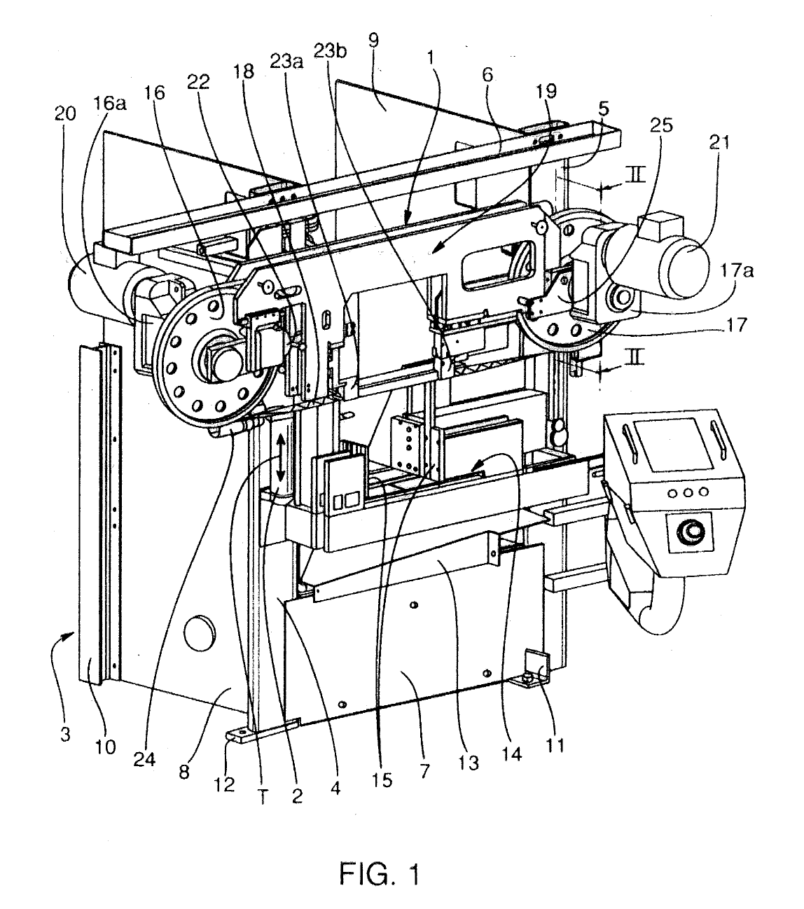

FIG. 1 shows schematically in a perspective view a device according to the invention,

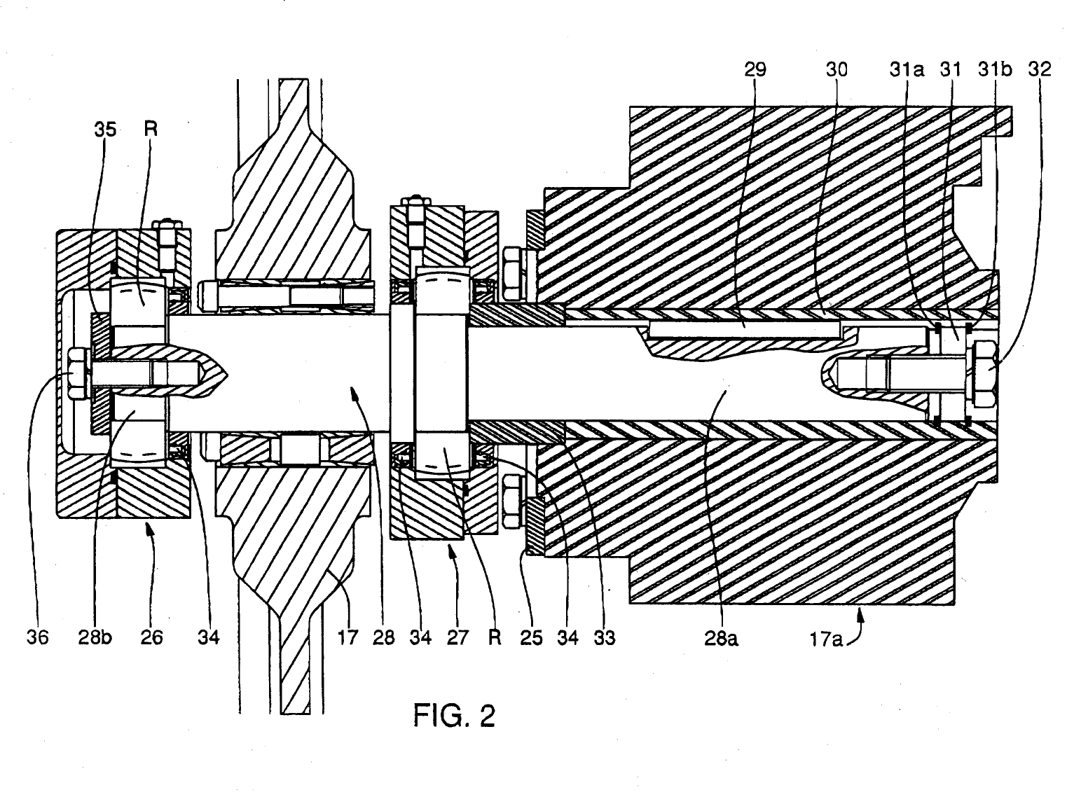

FIG. 2 shows schematically a view partially in cross-section on a vertical plane II-II of FIG. 1, of a driven wheel of the device according to the invention.

Referring to FIG. 1, metal sawing device according to the invention comprises a movable working assembly 1 supported by at least one support 2 secured to a base 3. The support 2 and the base 3 are rigidly inter-connected to constitute a frame of the device.

The device of FIG. 1 is of the type described in French patent application 98.15863 filed Dec. 16, 1998 and not published as of the date of the present application. According to the teaching of this document FR 98.15863, the base 3 is constituted by an assembly of metal sheets forming a lower portion of a housing adapted to receive concrete to form a base block ensuring the rigidity of the frame. The frame is constituted from two vertical uprights 4 and 5 interconnected by an upper crosspiece 6 and permitting assembly of sheets 7, 8, 9 together and their securement so as to constitute the casing adapted to receive concrete. At least one sheet 8 can be rigidified by a vertical upright 10, whilst the adjustment and the preliminary smoothing of the assembly of sheets before casting the concrete can be carried out by positioning at least one corner piece 11 relative to a securement base 12 to the ground. After casting the concrete, the foot 12 and the corner piece 11 are trapped in the concrete block after the latter sets up. An upper sheet 13 and an assembly 14 for supplying and holding metal bars are provided between the two vertical uprights 4 and 5. In a known manner, the metal bars are supplied by a rear conveyor mounted on a crosspiece secured to the concrete base and carrying a clamp for supplying the bars, movable step-wise. The clamp for supplying the metal bars advances the bars in a space or passage corresponding to the sawing. In this space, the bars (not shown) are maintained by holding clamps 15 to immobilize them in the course of sawing.

The movable assembly 1 comprises two wheels 16 and 17 on which is mounted a saw band 18. The wheels 16 and 17 are mounted on a portable structure 19 carrying at one end the wheel 16 and at the other end the wheel 17. The wheel 16 is a power-driven wheel, mounted displaceably with its drive motor 20, so as to place the saw band under a predetermined tension. The wheel 17 is also a wheel driven by an electric motor 21.

Preferably, a hollow shaft reducer 16a or 17a is interposed between each wheel 16 or 17 and its corresponding electric drive motor 20 or 21.

In FIG. 1, the reducers 16a, 17a and the motors 20, 21 are disposed on opposite sides of the vertical plane passing through the saw band 18. The invention is not limited to this arrangement, and also covers any other arrangement, on the same side as the vertical plane passing through the saw band, or with an angular offset relative to the vertical plane passing through the axis of the motor and through the axis of rotation of the corresponding wheel.

According to other constructional arrangements similar to those described in French patent application 98.15863 filed Dec. 16, 1998 and not published as of the date of the present application, a tensioning means 22 is provided to move the assembly of the driven wheel 16, its reducer 16a and its electric drive motor 20; the movable assembly 1 is movable on the support 2 forming a guide column so as to permit the movement of the movable assembly 1 in the direction of the arrow T; the portable structure 19 comprises two parallel plates carrying at each end a pair of bearings located on opposite sides of each wheel 16 or 17; straightening and guiding claims 23a, 23b are provided to straighten the saw band 18 in the vertical cutting plane; and a continuous cleaning device 24 for the saw band can be provided.

Preferably, the electric drive motors 20 and 21 are supplied by the same electrical supply with a frequency converter. Supplying the electric motors by a frequency converter has the advantage of being able to compensate any possible difference in diameter between the wheel 16 and the wheel 17, because it will be noted that the more heavily loaded motor undergoes slippage in its rotational movement relative to the frequency imposed by the common frequency converter. There is thus automatically obtained an optimum distribution of the load between the two motors, the power difference between the two motors being less than 5%.

This arrangement avoids any risk of slipping of the saw blade and permits increasing the productivity substantially proportionally to the increase of total consumed electrical power.

The anti-rotation arm 25 preventing the motor reducer 17a, 21 from turning about the wheel 17 is preferably used to measure continuously the rotative couple applied to the wheel 17 in the course of the sawing operation, so as to optimize the regulation of sawing in a manner known per se.

Referring to FIG. 2, the wheel 17 is shown mounted between two roller bearings 26 and 27 secured to the movable assembly 1, in particular by means of the anti-rotation arm 25. The wheel 17 is preferably mounted on a shaft 28 by a double cone locking device. The shaft 28 is mounted for rotation on rollers R mounted respectively in the bearings 26 and 27. The shaft 28 is thus mounted in a balanced manner on the two bearings 26 and 27, so that no force engendered by the tension in the saw band is transmitted to the external portion 28a. The shaft end 28a is keyed by means of a key 29 with a tubular drive shaft 30 of the hollow shaft reducer 17a.

Within the tubular shaft 30, two throats are provided to receive resilient rings 31a, 31b so as to ensure the securement of a washer 31 secured to the tubular shaft 30. A mounting, screw 32 ensures the securement of the rotating assembly thus constituted and transmits pressure to a blocking crosspiece 33 bearing on the internal portion of the corresponding roller R. Joints 34 over suitable lips are disposed on the bearings 26 and 27, and an end washer 35 fixed by a screw 36 is provided to block the opposite end 28b of the shaft 28 against the internal surface of the corresponding roller R.

The rotatable assembly constituted by the elements 28, 29, 30, 31, 31a, 31b, 32, 33, 35 and 36 is mounted in a balanced manner in the bearings 26, 27, such that no lateral pressure arising from the tension of the saw band will be applied to the hollow shaft reducer 17 at or on the drive motor 21. This arrangement consequently permits enabling the use of a motor reducer with a hollow shaft, of commercial type, not requiring being able to resist radial pressure or deviation along the axis of rotation of the shaft 28.

In addition to doubling the drive surface of the band saw, other particular and surprising advantages are obtained thanks to the invention; thus, a great improvement in the quality of the surface of the edge of the piece cut by the band saw and a great increase in the useful life of the band saw are noted.

The invention described with respect to a particular embodiment is in no way limited, but covers on the contrary any modification of form and any modification of embodiment within the scope and spirit of the invention.

What is claimed is:

1. In a device for sawing metal, comprising a movable working assembly (1) comprising a band saw (18), means to drive the band saw with an endless circulatory movement, and means for bringing metal workpieces below said movable assembly to saw them; the improvement wherein said assembly comprises at least two wheels (16, 17) for driving the band saw (18), said wheels being positioned on wither side of a passageway through which metal to be sawed passes, and motor means (20, 21) that separately drive each of the wheels (16, 17).

2. A device according to claim 1, wherein each wheel (16 or 7) is driven by means of a speed reducer (16a or 17a) with a hollow shaft (30).

3. A device according to claim 1, wherein said motor means (20, 21) for said two wheels (16, 17) are electrically-supplied by a supply with a frequency converter, so as to control the speed of each motor means (20, 21) with a common frequency.

4. A device according to claim 1, wherein each wheel (16, 17) is mounted between two symmetrical bearings (26, 27), so as to avoid any transmission of radial force to said motor means (20, 21).

5. A device as claimed in claim 1, wherein a said wheel (17) is provided with an anti-rotation bar (25) provided with a device for measuring a couple imposed on said arm (25) by said wheel (17) so as to control a speed of descent of said assembly (1).

6. A device as claimed in claim 1, wherein said motor means (20, 21) are mounted on opposite sides of a vertical plane passing through said band saw (18).

7. A device according to claim 1, and means mounting a said wheel (16) and its associated said motor means (20) for movement in a direction to tension said band saw (18).

8. A device according to claim 1, wherein each wheel (16, 17) includes intermediate drive structure (16a, 17a) connected by a key (29) to an extending end (28a) of a shaft (28) of a corresponding said wheel (16, 17).

9. A device as claimed in claim 8, wherein each intermediate drive means (16a, 17a) is a speed reducer with a tubular shaft (30) adapted to be fitted directly on said one end (28a).

10. A device according to claim 8, wherein each intermediate drive means (16a, 17a) comprises an element (31) for securement to an extending end of a shaft (28) of a wheel (16, 17) by removable means (32).
